(19) United States
(12) Patent Application Publication
(10) Pub. No.: US 2016/0003395 A1
(43) Pub. Date: Jan. 7, 2016

(54) MECHANICAL PIPE JOINT

(71) Applicant: CHEZY INDUSTRIES SDN. BHD, Shah Alam, Selangor Darul Ehsan (MY)

(72) Inventor: Sitsabasan A/L K.V. Velautham, Selangor (MY)

(73) Assignee: CHEZY INDUSTRIES SDN. BHD, Shah Alam, Selangor Darul Ehsan (MY)

(21) Appl. No.: 14/768,972

(22) PCT Filed: Mar. 19, 2014
(86) PCT No.: PCT/MY2014/000039

§ 371 Date: Aug. 19, 2015

(30) Foreign Application Priority Data
Apr. 2, 2013 (MY) PI 2013001168

(51) Int. Cl. F16L 37/092; F16L 21/03; F16L 47/08; F16L 21/00

(52) U.S. Cl. CPC F16L 37/0925; F16L 21/007; F16L 21/03; F16L 47/08

(57) ABSTRACT

A push-on pipe joint for connecting polyethylene water pipes comprises a hollow tubular body portion (1) having a central parallel-sided section (2) of internal diameter greater than that of the pipe and having a central inwardly extending pipe-stopping flange (5) for limiting insertion of the pipe, an inwardly tapered section (3) at each end of the central portion (1) and a further parallel sided end section (4) at the end of the tapered sections (3) of diameter such as to allow insertion of the pipe into the joint until it contacts the flange (5); a plurality of equidistantly spaced pipe-gripping members (7) inside the pipe joint and comprising a wedge section (11) having one surface (14) in sliding contact with the surface of the tapered section (3) and having ratchet teeth (18) on its opposite surface; means for forcing the wedge section (11) along the surface of the tapered section (3) to bring the ratchet teeth (18) into contact with, and to penetrate the surface of, the pipe; and a sealing ring ((9) located in a groove (8) towards the open end of the end sections (4) for forming a seal against the wall of a pipe inserted in the pipe joint.

This invention relates to mechanical pipe joints and, more particularly, to devices for joining water pipes of medium size above 63 mm.

### BACKGROUND TO THE INVENTION

According to BS EN 12201 joints between polyethylene water pipes must be able to withstand a pulling force of 4 tonnes for 125 mm pipes and 7 tonnes for 150 mm pipes.

Various forms of pipe joints have been proposed, and are in use, that fulfill the requirements of the standard but many of these have drawbacks that make them difficult to use.

Push-on joints have recently been developed and these, of course, make it very much simpler to make the pipe connections. Many of these push-on joints are complicated constructions, which makes them expensive. Cheaper but no less effective push-on joints would be desirable.

This invention provides such a joint.

### SUMMARY OF THE INVENTION

According to the invention a push-on pipe joint for connecting polyethylene water pipes comprises a hollow tubular body portion having a central parallel-sided section of internal diameter greater than that of the pipe and having a central inwardly extending pipe-stopping flange for limiting insertion of the pipe, an inwardly tapered section at each end of the central portion and a further parallel sided end section at the end of the tapered sections of diameter such as to allow insertion of the pipe into the joint until it contacts the flange; a plurality of equidistantly spaced pipe-gripping members inside the pipe joint and comprising a wedge section having one surface in sliding contact with the surface of the tapered section and having ratchet teeth on its opposite surface; means for forcing the wedge section along the surface of the tapered section to bring the ratchet teeth into contact with, and to penetrate the surface of, the pipe; and a sealing ring located in a groove towards the open end of the end section for forming a seal against the wall of a pipe inserted into the joint.

In a preferred form of the invention the wedge members are preferably formed with an integral hoop section formed of a somewhat resilient material and having a free leg attached to the wall of the central section in a holder adjacent the flange.

The pipe joint in this form of the invention of the invention operates as follows: when a pipe is introduced into the joint it first passes the sealing ring, which is, of course, appropriately sized. It then passes over the ratchet teeth of the pipe-gripping members without coming into contact with the teeth. On reaching the hoop section it compresses and somewhat flattens the hoop section causing the wedge section to slide over the cam surface formed by the tapered section of the joint to bring the ratchet teeth into contact with and to penetrate the outer surface of the pipe thus preventing the pipe from being removed from the joint.

The ratchet teeth of the pipe-gripping members are preferably formed of a harder and less resilient material than the rest of the members to ensure that the pipe is gripped as firmly as possible. In order to achieve this the ratchet teeth are preferably formed on an insert in the wedge section

To ease the sliding movement of the wedge section over the cam surface on the body the surface of the wedge section is preferably formed with transverse ridges, preferably with curved surfaces, to reduce the contact area between the two surfaces.

The number of pipe gripping members is variable but must, of course, be sufficient that the joint fulfils the requirements of the relevant Standard. It is possible to use as few as three or four but very many more can be used, as required or desired. It is necessary that a number of individual gripping members are used rather than a continuous gripping ring because there is always variation in the size and/or shape of extruded pipes caused by minor variances in manufacturing and by the use of a number of gripping members such variations can be accommodated.

The body of the pipe joint may be formed, from any material capable of withstanding the forces involved in usage but is preferably formed from polyethylene PE 100.

The gripping members may be made from a wide range of resilient materials, the main requirement being that the ratchet teeth should not be separable form the wedge section.

### DESCRIPTION OF PREFERRED EMBODIMENT

The invention will now be described in greater detail, by way of example, with reference to the attached drawings, in which:

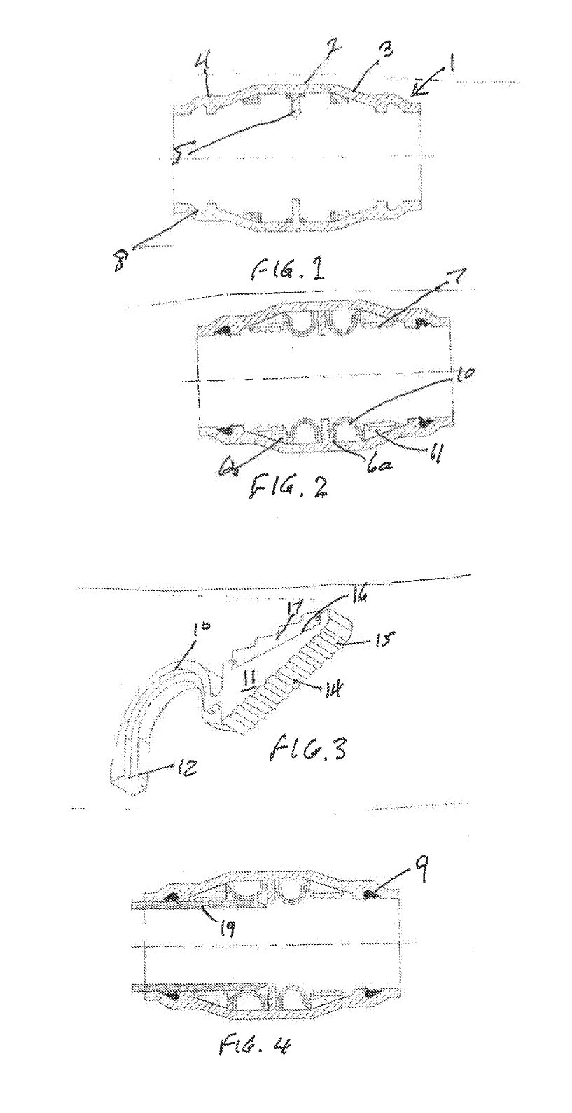

FIG. 1 is a section through the body portion of one form of pipe joint accordance with the invention;

FIG. 2 is a view similar to that of FIG. 1 but showing two gripping members mounted in position;

FIG. 3 is an isometric view of one form of gripping member; and

FIG. 4 is a side view as in FIG. 2 showing a pipe inserted in the joint.

As shown in FIG. 1, the body portion of the pipe joint comprises a hollow tubular member 1 having a parallel sided central section 2, an inwardly tapering section 3 on each end of the central section 2 and further generally parallel sided end sections 4 extending from tapering sections 3. An inwardly extending flange 5 is formed centrally of section 2 and protrudes beyond the parallel sides of end sections 4. Holding members 6a are positioned on either side of flange 5 and further holding members 6b are positioned at the opposed ends of central section 2. These holding members 6a and 6b hold pipe-gripping members 7 as described hereinafter with reference to FIGS. 2 and 3.

About halfway along the inner surfaces of end sections 4 are grooves 8 for receiving sealing rings 9 (see FIG. 4).

As shown in FIGS. 3 and 4, pipe-gripping members 7 comprise a hoop section 10 and an integrally formed wedge section 11. Hoop section 10 is of the same height as flange 5 and its free end 12 is received in holding member 6a. The other end 13 is received in holding member 6b. Wedge section 11 has a lower surface 14 that lies on the inclined surface 3a of tapering section 3 and is formed with a number of transverse ribs 15 having a part circular cross-section to reduce friction between the two surfaces.

Wedge section 11 on its upper surface 16 is formed with an insert portion 17 having ratchet teeth 18 on its outer surface.

Gripping members 7, apart from insert portion 17, are formed from a material that is somewhat resilient to the extent that when pressure is applied to the peak of hoop section 10 by pushing a pipe 19 into the joint, (see FIG. 3) the hoop opens and the gripping member elongates pushing wedge section along surface 3a and causing ratchet teeth 18 to penetrate the surface of pipe 19 and prevent its removal from the pipe joint.

1. A push-on pipe joint for connecting polyethylene water pipes comprising:
a hollow tubular body portion having a central parallel-sided section of internal diameter greater than that of the pipe and having a central inwardly extending pipe-stopping flange for limiting insertion of the pipe, an inwardly tapered section at each end of the central portion and a further parallel sided end section at the end of the tapered sections of diameter such as to allow insertion of the pipe into the joint until it contacts the flange;
a plurality of equidistantly spaced pipe-griping members inside the pipe joint and comprising a wedge section having one surface in sliding contact with the surface of the tapered section and having ratchet teeth on its opposite surface;
means for forcing the wedge section along the surface of the tapered section to bring the ratchet teeth into contact with, and to penetrate the surface of, the pipe; and a sealing ring located in a groove towards the open end of the end sections for forming a seal against the wall of a pipe inserted in the pipe joint.

2. A pipe joint according to claim 1, wherein the wedge members are formed with an integral hoop section formed of a somewhat resilient material and having a free leg attached to the wall of the central section in a holder adjacent the flange.

3. A pipe joint according to claim 1, wherein the ratchet teeth are formed on an insert in the wedge section.

4. A pipe joint according to claim 1, wherein the sliding surface of the wedge section is formed to transverse.

5. A pipe joint according to claim 4, wherein the ribs have curved surfaces, to reduce the contact area between the two surfaces.
